(19) United States
(12) Patent Application Publication
(10) Pub. No.: US 2026/0068811 A1
(43) Pub. Date: Mar. 12, 2026

(54) Cutting tool

(71) Applicant: Betek GmbH & Co. KG, Aichhalden (DE)

(72) Inventors: Helmut Widmaier, Aichhalden-Rötenberg (DE); Jochen Kern, Schiltach (DE); Fabian Seifried, Herrenzimmern (DE); Julian Roming, Schramberg (DE); Denis Rohrer, Villingen-Schwenningen (DE); Harald Roth, Dunningen (DE)

(21) Appl. No.: 18/950,890

(22) Filed: Nov. 18, 2024

(30) Foreign Application Priority Data
Sep. 11, 2024 (DE) 10 2024 126 062.9

(51) Int. Cl. A01D 34/14

(52) U.S. Cl. CPC A01D 34/14

(57) ABSTRACT

A cutting tool for an agricultural or forestry cutter bar includes a holder body including a longitudinal blade guide. At least one cutting attachment of the holder body includes a blade holder. A cutting element made of a more wear-resistant material than the material of the blade holder is attached to the blade holder. The cutting element includes at least one cutting edge which extends along or substantially along a cutting-edge side of the cutting attachment and which merges into a cutting surface of the cutting element.

### RELATED APPLICATION

The present application claims priority to German Patent Application Ser. No. DE 10 2024 126 062.9, filed Sep. 11, 2024, which is incorporated herein by reference.

### FIELD OF THE DISCLOSURE

The disclosure relates to a cutting tool for an agricultural or forestry cutter bar having a holder, which has a longitudinal blade guide, wherein the holder has at least one cutting attachment having a blade holder, wherein a cutting surface is disposed in the area of the blade holder, which cutting surface is designed and disposed in such a way that a cutting blade can be displaced along a cutting plane relative to the cutting surface.

Such cutting tools can, for instance, be the cutting fingers of a cutter bar, in particular of a blade mower, a double blade mower, a double blade cutter bar, a scythe mower, a hedge trimmer or a pruning shear.

On the one hand, the cutting tool is used to guide a moving blade. On the other hand, it acts as a counter blade for a blade to cut plants such as grasses, crops and hedges. Contact with soil, stones, etc. causes wear of the cutting tools in the area of their cutting edges, which reduces the performance of the machine and the quality of work.

### DESCRIPTION OF THE PRIOR ART

A cutting arrangement having a cutting tool is known, for instance, from EP 3 744 164 A1 (US 2022/0312671.)

### SUMMARY OF THE DISCLOSURE

The disclosure addresses the problem of providing a cutting tool of the type mentioned above, which makes for an improved work performance in the long term.

This problem is solved in that a cutting element, consisting of a more wear-resistant material than the material of the blade holder, is attached to the blade holder, and in that the cutting element has at least one cutting edge, which extends along or essentially along a cutting-edge side of the cutting attachment and which merges into the cutting surface.

The at least one cutting edge of the cutting tool is therefore formed by a component, namely the cutting element, which has a high resistance to wear. This ensures that the cutting edge permanently retains its shape during machining and guarantees a good cutting performance. Advantageously, the cutting surface, on which the blade can slide, is also formed by the cutting element and therefore also has a good wear resistance. In particular, as a consequence, the wear at the contact area between the blade and the cutting surface is reduced. This prevents stalks from being pulled into this area, which can be a problem in particular in damp weather. In this way, the cutting performance can be maintained, resulting in improved efficiency compared to conventional solutions. Compared to the cutting element, the blade holder can be made of a comparatively more ductile material, i.e., the bending stresses acting on the cutting tool during use are safely absorbed. For instance, the blade holder can be made from a steel material and the cutting element from a hard material, such as carbide (tungsten carbide) or ceramic material. It is also conceivable for provision to be made for the steel material of the blade holder to be surface-hardened and/or borated, at least sectionally. Advantageously, the cutting element consists of a molded body, in particular a sintered component, which is connected to the blade holder.

To reduce the number of parts required, provision may be made for the cutting element to have a cutting edge on each of its opposite longitudinal sides, wherein the cutting edges each extend along one cutting edge side of the cutting attachment. However, it is also conceivable for provision to be made for a cutting element having a cutting edge to be provided on opposite longitudinal sides of the blade holder. This reduces the amount of material required for the relatively expensive hard material.

Within the scope of the disclosure, provision may be made to use several cutting elements disposed in a row, each forming a cutting edge, wherein the individual cutting edges of the cutting elements then form a joint cutting edge. This reduces the risk of breakage for the cutting element, in particular if strong bending stresses are to be expected.

Within the scope of the disclosure, provision may also be made for the cutting edges to extend in parallel to each other or to converge in the direction of the free end of the cutting attachment. Cutting edges that extend in parallel to each other then usually interact with knives having cutting edges, which are set at an angle to the cutting edges of the cutting element. If converging cutting edges are used, these can preferably also interact with cutting edges of blades that extend at an angle thereto to be able to implement a particularly effective cut, in particular a scissor cut.

A particularly preferred variant of the disclosure is such that the cutting element is formed by a hard material piece, in particular by a hard metal piece (tungsten carbide piece). It has been shown that such hard-material pieces can effectively withstand the load forces involved, in particular in combine harvesters.

A conceivable alternative disclosure can be such that the cutting element has a front surface facing the free end of the cutting attachment, and in that the front surface is covered at least sectionally by an edge of a body of the cutting attachment transversely to the longitudinal extent of the cutting edge. This protects the front of the cutting element, which is particularly susceptible to breakage during machining due to the feed motion of the cutter bar in the feed direction. As a result, the risk of conchoidal fractures at the cutting tool is reduced, in particular if the cutting element is made of carbide.

A cutting tool according to the disclosure can be of such a type that the cutting element has a rear end facing away from the free end of the cutting attachment, which rear end is opposite from an end surface of a transition section, wherein the transition section forms a transition between the longitudinal blade guide and the cutting attachment. This results in a compact design that also offers good wear protection against the blade sliding along the cutting surface.

According to a variant of the disclosure, provision may also be made for the cutting element to have a bottom, preferably flat, connecting surface, which is used to bond the cutting element to an opposing mating surface of the connecting section of the cutting attachment. In particular, provision may be made for a cohesive bond, in particular a soldered, glued and/or welded connection, to be disposed between the mating surface and the connecting surface. In this way, a secure and highly resilient connection is created. In particular, a soldered and/or a glued connection can preferably be designed in such a way that it forms an elastic connecting layer in a way, to dampen shock loads acting on the cutting element. This reduces the risk of breakage of the cutting element. Preferably, the cutting element is underlaid in the area of its connecting surface, preferably across the entire surface. This also reduces the risk of breakage.

A possible variant of the disclosure can also be such that a cutting tip of the cutting element is used to merge the two converging cutting edges into each other in the area of the free end of the cutting attachment. Preferably, the cutting edge is convexly rounded to improve the stability of the cutting element.

For easier maintenance of the cutting tool, provision may be made for the cutting element to be connected to the cutting attachment in a replaceable manner, preferably by means of at least one fastening element, in particular by means of at least one screw or bolt. In the event of damage, the cutting element can then simply be replaced. It is also conceivable that the cutting attachment forms a replaceable part of the cutting tool. It can then be replaced together with the cutting element in the event of damage.

A particularly effectively working cutting tool can be created in that the cutting attachment has a cover section, which is disposed at a distance from the blade holder, wherein a blade gap is formed between the blade holder and the cover section, and in that the cutting element, which is borne by the blade holder, delimits the blade gap at least sectionally by means of its cutting surface.

Provision may also be made for the cover section to bear at least one further cutting element in the area of the blade gap, which cutting element is designed as a separate component and connected, preferably connected in a replaceable manner, to the cover section, wherein particularly preferably provision may be made for the cutting element and the further cutting element to be designed as identical parts. This means that the cutting tool provides at least one cutting edge on each of the two opposite sides of the blade gap. In this way, appropriately designed blades can be used to implement a double cutting function.

If provision is made for the/a cover section of the cutting attachment to be disposed at a distance from the blade holder by means of a connecting element disposed at the end of the cutting attachment such that the blade gap is formed between the cover section and the blade holder, then the connecting element protects the cutting element from any stresses acting on the front.

According to a variant of the disclosure, provision may also be made for the at least one cutting attachment with the cutting element is attached thereto to form a first component, which is connected, preferably connected in a replaceable or non-replaceable manner, for instance welded, to a second component, which preferably has the longitudinal blade guide. In this way these two components can be endowed with different properties. For instance, the component that forms the blade guide is specifically designed for the frictional wear occurring there. A replaceable connection between the two components again reduces maintenance costs in the event of damage.

The problem of the disclosure is also solved by a sickle bar for a combine harvester cutter bar, a blade mower, a double-blade mower, a double-blade cutter bar, a bar mower, a hedge trimmer or a branch cutter, having at least one cutting tool according to the disclosure.

### BRIEF DESCRIPTION OF THE DRAWINGS

The disclosure is explained in greater detail below based on exemplary embodiments shown in the drawings. In the figures,

FIG. 1 shows a perspective view of a cutting tool from below,

FIG. 2 shows a perspective view of the cutting tool of FIG. 1 from the top,

FIG. 3 shows a view of the cutting tool of FIGS. 1 and 2 from the top,

FIG. 4 shows a side view of the cutting tool of FIGS. 1 to 3,

FIG. 5 shows the cutting tool of FIGS. 1 to 4 along the cutting path marked V-V in FIG. 3,

FIG. 6 shows a perspective view of a further design variant of a cutting tool,

FIG. 7 shows a perspective view of the cutting tool of FIG. 6 from the top,

FIG. 8 shows a horizontal section through the cutting tool of FIGS. 6 and 7,

FIG. 9 shows a section through the cutting tool along the cutting path marked IX-IX in FIG. 8,

FIG. 10 shows a further design variant of a cutting tool along the cutting path marked X-X in FIG. 11,

FIG. 11 shows a side view of the cutting tool of FIG. 10 and

FIG. 12 shows the cutting tool along the cutting path marked XII-XII in FIG. 10.

### DETAILED DESCRIPTION

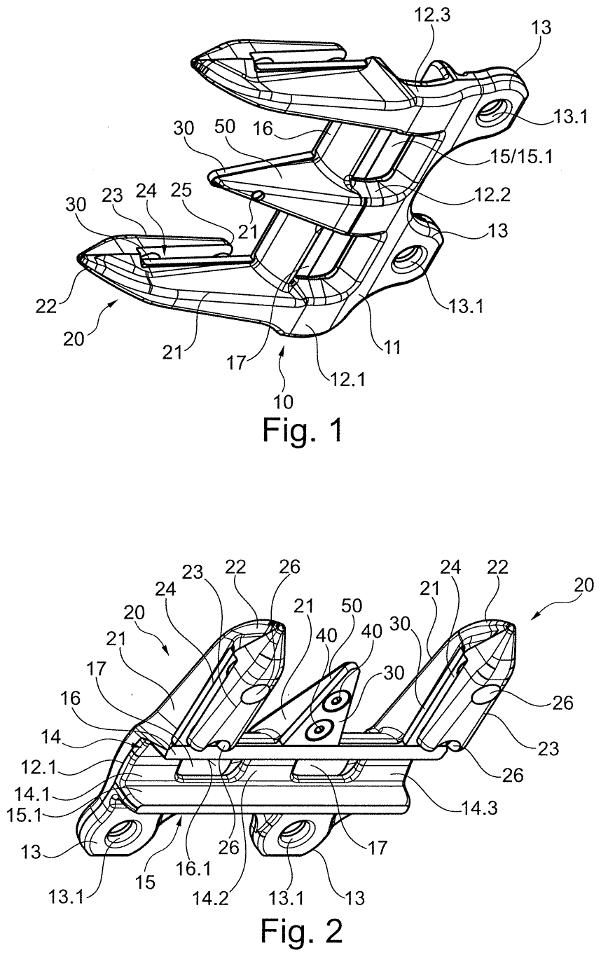

FIG. 1 shows a cutting tool 10 having a holder 11. The holder 11 may also be referred to as a holder body 11. The holder 11 has a blade guide 14, which can be integrally formed with the holder 11. As FIG. 2 shows, the blade guide 14 can be designed such that it has one or more guide pieces 14.1, 14.2, 14.3.

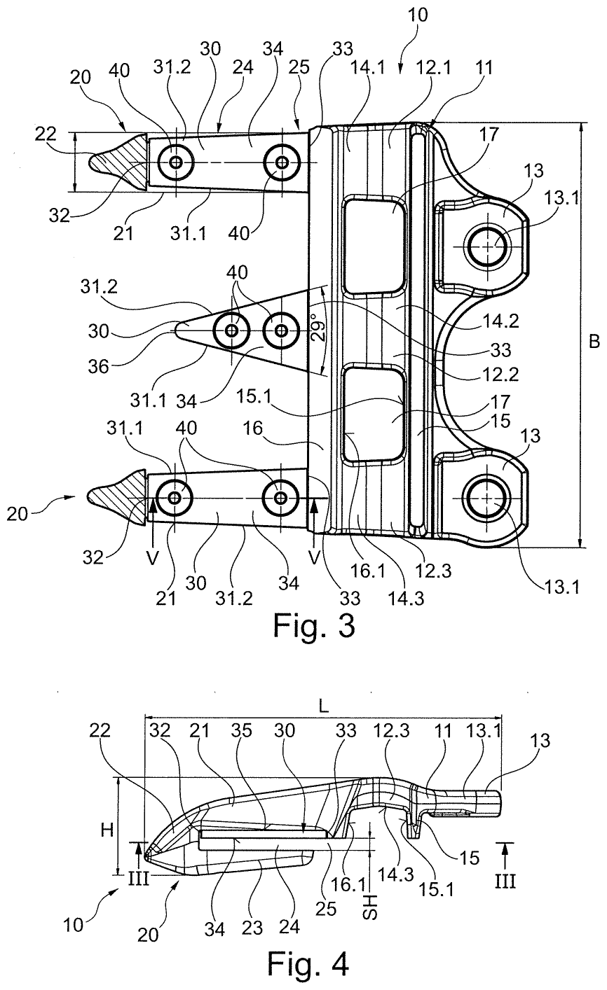

A guide attachment of a blade arrangement not shown can be guided in a displaceable manner on or at this at least one guide piece 14.1, 14.2, 14.3. The displacement motion of the blade arrangement occurs from top to bottom and vice versa in an oscillating motion as shown in FIG. 3. To guide the blade arrangement, the blade guide 14 can also be designed in such a way that it has two lateral boundary surfaces 15.1, 16.1, which are spaced apart from each other and also extend in the guide direction. They prevent the blade arrangement from deviating at right angles from the longitudinal guide direction of the blade guide 14.

The boundary surface 15.1 may be formed by a wall element 15, which is integrally formed on the holder 11. It is conceivable that the boundary surface 16.1, which is at a distance from the boundary surface 15.1, is integrally formed by a transition section 16 of the holder 11.

Advantageously, the guide pieces 14.1, 14.2, 14.3 are formed by bars 12.1, 12.2, 12.3, which are preferably disposed at a distance from one another across the width of the cutting tool 10.

FIGS. 1 to 3 illustrate that there is at least one aperture 17 in the area of the blade guide 14, which is preferably formed between two bars 12.1, 12.2, 12.3 disposed adjacent to each other. Any organic material that may have entered the area of the blade guide 14 can be conveyed out of the area of the blade guide 14 through these openings 17. As shown in FIG. 3, the cutting tool 10 has a width B and, according to FIG. 4, a length L perpendicular thereto. The guide direction of the blade guide 14 extends in the direction of the width B.

Advantageously, one or more fastening attachments 13 are connected to the holder 11, preferably integrally, and are disposed at a distance from one another in the width direction. The fastening attachments 13 can have attachment mounts 13.1, for instance holes. The cutting tool 10 can be fastened to a cutter bar (not shown) by means of the at least one fastening attachment 13.

As the figures, in particular FIGS. 3 and 4, show, the cutting tool 10 has at least one cutting attachment 20, 50. Advantageously, the cutting attachment 20, 50 is integrally formed on the holder 11. Preferably, the at least one cutting attachment 20, 50 integrally adjoins the transition section 16. The at least one cutting attachment 20, 50 extends in the direction of the length L of the cutting tool 10.

The cutting attachment 20, 50 has a blade holder 21 that adjoins the transition section 16. As mentioned above, the blade holder 21 can be integrally connected to the transition section 16. However, it is also conceivable that the cutting attachment 20, 50 is interchangeably connected to the holder 11.

In this exemplary embodiment, three cutting attachments 20, 50 are used, which are disposed at a distance from one another in the direction of the width B. Preferably, the two outer cutting attachments 20 protrude in the direction of the length L of the cutting tool 10 beyond the central cutting attachment 50, which is disposed between the two outer cutting attachments 20. It is also possible for the central cutting attachment 50 to protrude beyond the outer cutting attachments 20 or for all cutting attachments to protrude equally far.

At least one cutting attachment 20 may form or may have a connecting element 22 at its longitudinal end facing away from the holder 11. This connecting element 22 adjoins a cover section 23. Preferably, as shown in the drawings, the blade holder 21, the connecting element 22 and the cover section 23 are integrally formed.

There is a blade gap 24 between the blade holder 21 and the cover section 23. A blade of the blade arrangement can be displaced linearly in this blade gap 24. FIG. 4 shows that the blade gap 24 has an insertion section 25 facing the holder 11. The blade is guided outwards through this insertion section 25 and coupled to the guide section of the blade arrangement, which is guided in the blade guide 14.

The height of the blade gap is marked SH in FIG. 4. Preferably, the height of the blade gap 24 is selected in the range between 2 mm and 10 mm. The height SH is preferably selected in the range between 3 mm and 6 mm.

As the drawings illustrate, the blade holder or holders 21 bear cutting elements 30. The design of the cutting elements 30 can be seen in FIGS. 3 and 4. As these illustrations show, at least one of the cutting elements 30 may be designed as a plate-shaped molded body.

The cutting element 30 is designed as a separate component that is connected to the blade holder 21. The cutting element 30 is made of a material that is more wear-resistant than the material of the blade holder 21. In particular, the cutting element 30 can be made of a hard metal (tungsten carbide). It is also conceivable that the cutting element 30 is designed as a ceramic element.

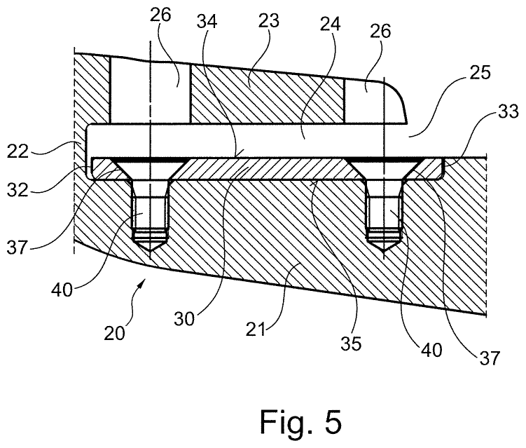

The cutting element 30 can be interchangeably connected to the blade holder 21, as shown in FIGS. 3 to 5. For this purpose, a fastening element 40 is used to connect the cutting element 30 to the blade holder 21.

For this purpose, the cutting element 30 may have at least one bolt mount 37, through which the fastening element 40 in the form of a fastening bolt is passed and bolted into a bolt mount of the blade holder 21.

However, it is also conceivable that the cutting element 30 is not connected to the blade holder 21 in a replaceable manner, for instance is connected thereto in an adhesive bond. It is conceivable that the cutting element 30 is connected to the blade holder 21 by means of a soldered or glued connection.

If, as in this exemplary embodiment, a cover section 23 is used, then the cover section 23 may have one or more feedthroughs 26, through which the fastening element 40 can be installed.

As FIG. 3 shows, the cutting element(s) 30 has/have at least one cutting edge 31.1, 31.2. The cutting edges 31.1, 31.2 preferably extend linearly in the direction of the longitudinal extent of the cutting attachments 20, 50.

FIG. 3 shows that two cutting edges 31.1, 31.2 of the two outer cutting attachments 20 are disposed in parallel to each other. However, it is also conceivable that the two cutting edges 31.1, 31.2 are disposed at an angle to each other. This is illustrated using the example of the central cutting attachment 50. Preferably, the two cutting edges 31.1, 31.2 converge in the direction of the free end of the cutting attachment 50. A cutting tip 36 may be used to merge the two cutting edges 31.1, 31.2 at the free end of the cutting element 30. The cutting tip 36 can be rounded to reduce the risk of breaking.

Preferably, the cutting element(s) 30 have a uniform thickness in the direction of the height of the cutting tool 10, as shown in FIG. 4. Preferably, the thickness of the cutting element(s) 30 is selected in the range between 1.5 mm and 4 mm.

FIGS. 3 and 4 show an interchangeable connection of the at least one cutting element 30. However, it is also conceivable that the cutting element 30 is additionally or alternatively connected to the blade holder 21 by means of a cohesive bond.

For instance, a glued or soldered connection can be provided as an adhesive bond.

The adhesive bond can be formed between a preferably flat connecting surface 35 facing the blade holder 21 and an opposite contact surface of the blade holder 21.

If, in addition to the adhesive bond, a connection by means of a fastening element 40 is used, the cutting element 30 can be pretensioned in relation to the blade holder 21 when forming the adhesive bond to produce a gap thickness in the adhesive bond that is as uniform as possible. It is also conceivable that, when the adhesive bond has been formed, the fastening element 40 is removed again and the cutting element 30 is held on the blade holder 21 solely via the adhesive bond.

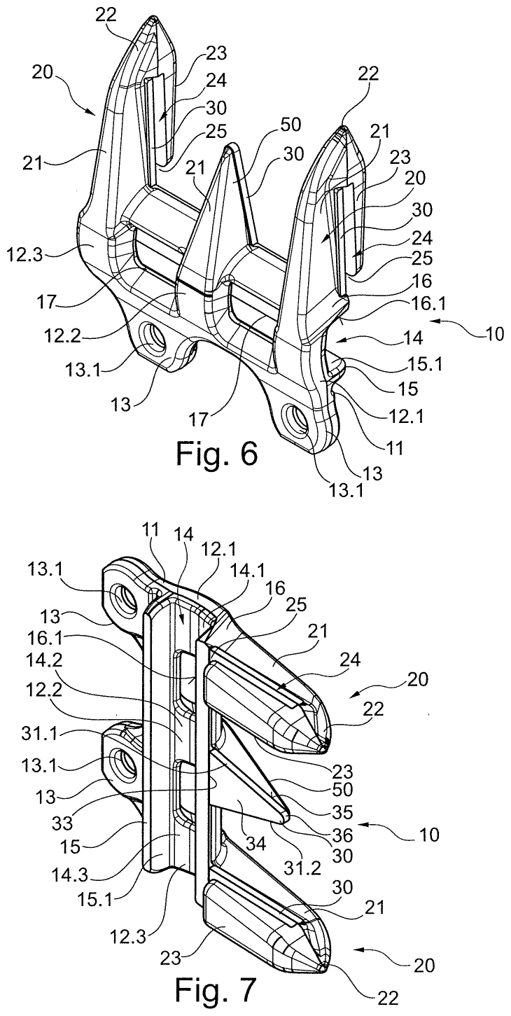

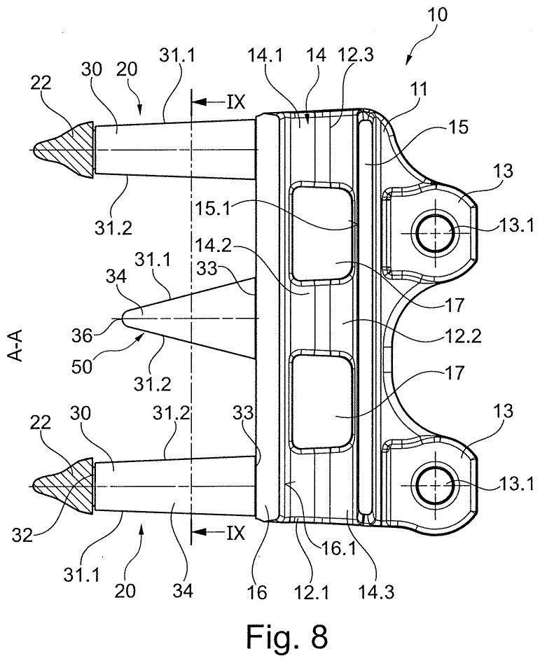

FIGS. 6-8 show a design variant of the disclosure. The cutting elements 30 are connected to the blade holder 21 exclusively by means of an adhesive bond, preferably a soldered or glued connection.

In all other respects, the design of the cutting tool 10 matches the design variant shown in FIGS. 1-5, i.e., reference can be made to the above explanations.

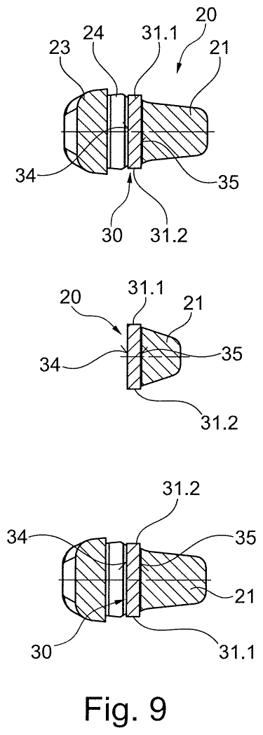

FIG. 9 shows a detail of a cutting tool 10 as shown in FIGS. 6 to 8, where the design of the cutting elements 30 and the blade holders 21 can be seen in more detail. As this image illustrates, the blade(s) 31.1, 31.2 of the cutting element(s) 30 may project laterally in the direction of the width B beyond the blade holder 21. For this purpose, the flanks of the blade holders 21 adjoining the cutting edges 31.1, 31.2 at the bottom may be set in a V-shape in relation to each other to form tool flanks in the direction of the height of the cutting tool 10, as FIG. 9 clearly shows.

However, it is also conceivable that the at least one cutting edge 31.1, 31.2 merges flush into the blade holder 21, i.e., it does not protrude laterally in the direction of the width.

The illustrations further show that the cutting element 30 can have a front surface 32, which closes off the cutting element 30 at its free end facing away from the holder 11. This front surface 32 may be protected behind a mold surface of the blade holder 21. For instance, as FIG. 4 illustrates, this mold surface can be formed by the connecting element 22.

Advantageously, the cutting element 30 has a rear end 33, which closes off the cutting element 30 when facing the holder 11. The cutting element 30 may be inserted into a mount, in particular a milled recess in the blade holder 21, such that the rear end 33 can be positioned precisely in this milled recess. This means that the cutting element 30 is precisely aligned with the blade holder 21.

The cutting element 30 has a cutting surface 34, which merges into at least one cutting edge 31.1, 31.2. Advantageously, the cutting edge 31.1, 31.2 forms a transition between the cutting surface 34 and a lateral surface of the cutting element 10, as FIG. 9 shows.

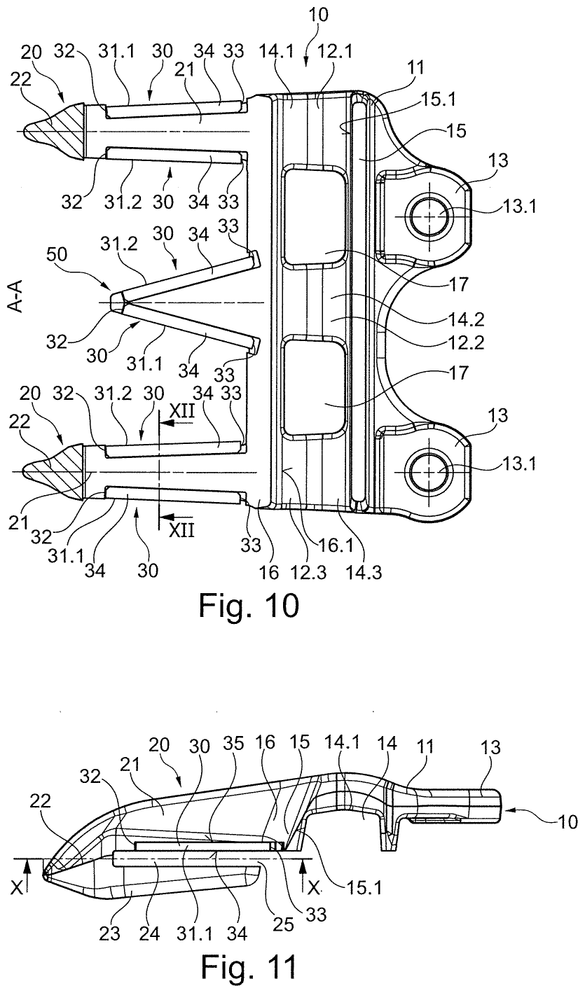

FIGS. 10 to 12 show a further exemplary embodiment of the disclosure. Identical reference numerals refer to identical terms, i.e., reference can be made to the above explanations to avoid repetition.

As the illustrations show, instead of a uniform cutting element 30 having two blades, two cutting elements 30, each having one cutting edge 31.1, 31.2, can also be installed using one blade holder 21. Preferably, each of the cutting elements 30 is positioned in a recess of the blade holder 21, as FIG. 10 clearly shows.

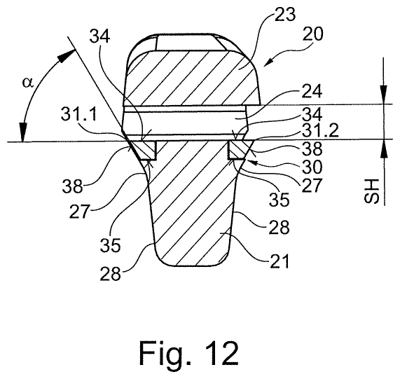

FIG. 12 shows a further design variant of a cutting element 30. The detail shown in FIG. 12 can also be applied to the other cutting elements 30 shown in FIGS. 1 to 11. As this illustration shows, the cutting element 30 has a tool flank 38. The tool flank 38 is set at an angle of less than 90° to the cutting surface 34, resulting in a clearance angle α. The clearance angle α is preferably selected in the range from 45° to 75°. The diagram further illustrates that the blade holder 21 can have a flank 27 adjacent to the cutting element 30, which tapers the cross-section of the blade holder 21 below the cutting element 30. Preferably, the inclination of this flank 27 is selected to be equal to the angle of inclination between the tool flank 38 and the cutting surface 34 with a deviation of ±10°.

1-15. (canceled)

16. A cutting tool, comprising:
a holder body including a longitudinal blade guide and at least one cutting attachment, the at least one cutting attachment including a blade holder; and
a cutting element attached to the blade holder, the cutting element being formed of a more wear-resistant material than a material of the blade holder, the cutting element including at least one cutting edge extending along a cutting-edge side of the cutting attachment, the at least one cutting edge merging into a cutting surface of the cutting element, the cutting surface being configured such that a cutting blade received in the longitudinal blade guide and the blade holder can be displaced along a cutting plane relative to the cutting surface of the cutting element.

17. The cutting tool of claim 16, wherein:
the at least one cutting edge of the cutting element includes two cutting edges, one on each of two opposite longitudinal sides of the cutting element, and each of the two cutting edges extend along a respective cutting-edge side of the cutting attachment.

18. The cutting tool of claim 17, wherein:
the two cutting edges of the cutting element extend in parallel to each other.

19. The cutting tool of claim 17, wherein:
the two cutting edges of the cutting element converge in a direction of a free end of the cutting attachment.

20. The cutting tool of claim 16, wherein:
the cutting element is formed of tungsten carbide.

21. The cutting tool of claim 16, wherein:
the cutting attachment includes a free end; and
the cutting element includes a front surface facing toward the free end of the cutting attachment, and the front surface of the cutting element is at least partially covered by the cutting attachment transversely to a longitudinal extent of the cutting edge of the cutting element.

22. The cutting tool of claim 16, wherein:
the cutting attachment includes a free end;
the holder body includes a transition section forming a transition between the longitudinal blade guide and the cutting attachment, the transition section including a side face; and
the cutting element includes a rear end facing away from the free end of the cutting element, the rear end opposing the side face of the transition section.

23. The cutting tool of claim 16, wherein:
the cutting element includes a flat connecting surface bonded by a cohesive bond to an opposite mating surface of the cutting attachment, the cohesive bond being a soldered, glued and/or welded bond.

24. The cutting tool of claim 16, wherein:
the at least one cutting edge of the cutting element includes two cutting edges, one on each of two opposite longitudinal sides of the cutting element, the two cutting edges of the cutting element converging in a direction of a free end of the cutting attachment, and the cutting element includes a cutting tip merging the two converging cutting edges.

25. The cutting tool of claim 16, wherein:
the cutting element is replaceably connected to the cutting attachment by at least one screw or bolt.

26. The cutting tool of claim 16, wherein:
the cutting attachment includes a cover section disposed at a distance from the blade holder thereby defining a blade gap between the blade holder and the cover section; and
wherein the cutting surface of the cutting element delimits the blade gap at least partially.

27. The cutting tool of claim 26, wherein:
the cover section bears a further cutting element adjacent the blade gap, the further cutting element being replaceably connected to the cover section, the cutting element and the further cutting element being configured as identical parts.

28. The cutting tool of claim 16, wherein:
the cutting attachment includes a cover section disposed at a distance from the blade by a connecting element disposed at a free end of the cutting attachment, thereby defining a blade gap between the blade holder and the cover section.

29. The cutting tool of claim 16, wherein:
the cutting attachment with the cutting element attached thereto forms a first component of the cutting attachment connected to a second component of the cutting attachment including the longitudinal blade guide.

30. The cutting tool of claim 16, in combination with a sickle bar for a combine cutter bar, a double-blade mower, a double-blade cutter bar, a bar mower, a hedge trimmer or a branch cutter.
